(19) United States
(12) Patent Application Publication
(10) Pub. No.: US 2006/0163349 A1
(43) Pub. Date: Jul. 27, 2006

(54) Wireless systems suitable for retail automation and promotion

(75) Inventor: Charles F. Neugebauer, Los Altos, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: W5 Networks, Inc.

(21) Appl. No.: 11/241,791

(22) Filed: Sep. 30, 2005

Related U.S. Application Data
(60) Provisional application No. 60/614,642, filed on Sep. 30, 2004.

(51) Int. Cl. G06K 15/00

(52) U.S. Cl. 235/383

(57) ABSTRACT

Systems, apparatus and methods for retail automation and promotions are taught. Wireless tracking devices preferably include means for storing and wirelessly transmitting unique identification keys. One or more wireless access points receive the wireless signals from the wireless tracking devices. A controller or server communicates with the wireless access point(s). Optionally, the server determines the locations of the wireless tracking devices based upon the transmitted signals.

### CROSS-REFERENCE TO RELATED APPLICATIONS

This application claims the benefit of U.S. provisional application No. 60/614,642, filed on Sep. 30, 2004, which is incorporated herein by reference.

### FIELD OF THE INVENTION

The present invention relates wireless devices and more particularly applies to wireless systems that may be advantageously utilized in retail applications.

### BACKGROUND

Price change labor represents a significant expenditure in many retail businesses. The high cost of making price changes limits the ability of retailers to optimize prices. The recent advent of sophisticated computerized pricing software has generated a need for an accurate, low cost means of updating prices on retailers' shelves. Electronic shelf labels (ESLs) have been proposed as a solution but have met with only limited success due to their high cost.

Trade promotion allowances paid by manufacturers to retailers represent a significant fraction of overall marketing spending for consumer packaged goods (CPG) companies. One recent estimate puts CPG trade promotion spending at over $100 B/yr in the US alone. Promotion efficiency (defined as the effectiveness with which promotion spending is converted into incremental sales) is a critical metric for evaluating promotion methods; another study found over 80% of all retail promotions lose money.

Therefore, there is a long-felt need for systems, apparatus and methods that enable more efficient application of advertising resources and provide incentives for customers to use such systems, apparatus and methods.

U.S. Pat. No. 6,577,275 discloses a wireless system that includes tracking tags issued to a customer upon entering a store. The tracking tags include a memory that stores customer identification information and the system is capable of tracking the movement of the customer through the store by means of the tracking tag. One or more electronic messaging units are distributed throughout the store and a customer associated database can be accessed when the customer enters a certain location in the store so as to issue customer-specific advertising messages on the electronic messaging units. In an alternate embodiment, shopping carts can be equipped with a wireless tag and the customer can scan customer identification information into the wireless tag. Thereafter, the system tracks the wireless tag on the shopping cart in order to issue the above-noted customer-specific messages.

WO 98/38589 discloses an infra-red based wireless system that also requires the customer to initialize a transmitter attached to the shopping cart so as to track movement of the customer through the store. Customer-specific promotions can be displayed on graphic displays when the customer reaches particular locations in the store.

However, both these system suffer from several disadvantages. For example, the customer is required to either scan or enter customer identification into the wireless tracking tag, which would be awkward for the customer and is expected to lead to inefficient usage of the tracking system. If the tracking tags are not mounted on the shopping cart, the store is required to re-collect the tracking tags before the customer leaves the store. In addition, the customer may not even notice the customer-specific advertising displayed on the electronic messaging units.

U.S. Pat. No. 6,177,880 describes a handlebar display that is mounted on shopping carts, which are tracked by a wireless transmitter disposed in the display. The handlebar display may display a customer shopping list, the location of a product in the store and/or promotional offers.

U.S. Pat. No. 5,572,653 discloses an infra-red system having wireless tags that can be attached shopping carts or baskets. The wireless tags can be tracked through the store so as to display promotional offers on fixed or movable displays when the customer reaches certain locations within the store.

While the wireless system of these two U.S. patents purport to track the shopping cart as it moves through the store, so as to display promotional offers on the handlebar display when the shopping cart reaches predefined areas within the store, these systems are not capable of displaying customer-specific advertising. Thus, many or most of the displayed promotions may be ignored by the customer as being irrelevant.

U.S. Pat. No. 6,513,015 discloses a wireless tag that stores customer identification information. When the customer enters the store carrying this wireless tag, tag readers placed at the store entrance read the customer identification information transmitted by the tag and assess a customer database. Customers matching certain requirements of the database are then photographed and the customer information and photograph are made available to store employees in order to improve customer service. However, this system is not capable of tracking the location of the customer in the store or wirelessly providing customer-specific advertising to the customer.

U.S. Pat. No. 6,317,082 discloses a wireless call tag based material replenishment system having a wireless transceiver and a push button for requesting replenishment of components in an assembly line or other manufacturing environment.

U.S. Pat. No. 6,736,316 discloses a wireless system for tracking the location of electronic price labels.

U.S. Pat. No. 6,539,393 discloses a wireless system for locating items within a facility using a wireless badge that periodically transmits a unique identification code. A receiver provides received identification codes and a processor assesses a database to correlate the received identification code with a person. The received signals are also utilized to determine the location of the badge, whereby the processor can collect customer location data within the facility.

U.S. Pat. No. 6,236,335 discloses a wireless tag tracking system that utilizes signal strength measurements to track movement of the tags through a retail system. However, this system requires the tags to always transmit with the same signal strength, thereby inefficiently utilizing the tag's power battery resources.

U.S. Pat. No. 6,590,537 discloses a wireless tracking system in which a master broadcast center transmits a high power RF signal in the 400-450 MHz band to all mobile receivers. The high power RF signal contains a reference time tag and a string of activation codes for the mobile receivers of interest. The mobile receivers respond to activation signals with a lower power broadcast on a separate frequency in the 400-450 MHz band.

U.S. Pat. No. 6,012,244 describes a wireless retail promotion system for location based promotion delivery.

### SUMMARY

An object of the present invention is to overcome one or more of the problems of the known art.

In its fullest development, the present teachings provide an integrated wireless-based system for automatically recognizing customers and wirelessly communicating with one or more other wireless devices, thereby providing an improved shopping experience to the customer and improving retail and advertising efficiency. However, as will be understood, the following aspects of the present teachings may be utilized alone or in combination to achieve the object of the present invention.

The present teachings provide a plurality of wireless access points (APs) that are spatially distributed, e.g. in a grid, within a facility. The APs are capable of receiving wireless signals from one or more types of wireless tags. Information from the wireless tags may be processed and supplied, via a wireless or wired local area network (LAN), to one or more central processors, such as one or more servers. The one or more central processors may further process the information from the APs. In certain aspects of the present teachings, one or more databases may be accessed in order to generate signals that are supplied to the one or more wireless tags via the APs.

In one aspect of the present teachings, the wireless system is capable of determining the location of the one or more wireless tags within the system, as well as to track movement of the wireless tags through the facility. This location/tracking information can then be utilized to supply useful information to facility personal and/or to customers via one or more types of wireless tags.

In another aspect of the present teachings, the one or more wireless tags may include battery-powered “loyalty tokens” that are adapted to store and transmit a unique identification (ID) code. The system preferably is adapted to associate the received unique ID code with a particular customer and the system, e.g., the server, preferably includes a customer database. The loyalty tokens are preferably a portable, battery-powered wireless transceiver that can be given to the customer, e.g., as part of a loyalty or “frequent shopper” program. When the customer enters the facility or retail establishment carrying the loyalty token, the APs receive signals transmitted from the loyalty tag and automatically recognize that the customer has entered the store. Thereafter, the wireless system is preferably capable of tracking the location of the customer within the store by utilizing signals transmitted from the wireless tag. As will be explained below, various additional function features are enabled by the loyalty tokens of the present teachings.

In a preferred embodiment of this aspect, the loyalty token may include an input device, such as a button, touch pad, capacitive switch, etc., which the customer can activate in order to perform one or more functions that will be further described below. Optionally, the loyalty tokens also may include a display for displaying information transmitted from the server via the APs.

In another aspect of the present teachings, the one or more wireless tags may include battery-powered movable displays, which preferably may be mounted on or attached to a shopping cart, e.g., the handlebar of the shopping cart, or basket. The movable displays are also preferably capable of wirelessly transmitting signals that can be tracked by the system. The movable displays are preferably capable of displaying one or more of, e.g., promotional product prices, shopping lists, coupon offers or previously stored electronic coupons (described below), etc., as will be further discussed below.

In a preferred embodiment, when the customer selects a shopping cart or basket, the system automatically associates the customer with the selected cart or basket based upon at least location information. For example, the system preferably can detect when a cart or basket begins moving based upon the above-noted locating tracking capability. If the system detects a customer, based upon the transmitted unique ID code from the customer's loyalty token, moving together with the cart or basket, the system can associate the movable display, which is optionally mounted on the cart or basket, with the customer. Naturally, the movable display may also be provided separately from a cart or basket.

In addition or in the alternative, the movable display optionally may be associated with the customer upon activation of the input device on the loyalty token. For example, when the customer selects the cart or basket, the customer can activate the input device on the loyalty token, whereby the loyalty token transmits a movable display association signal to the APs. The server then utilizes this signal to associate the movable display with the customer.

In a particularly preferred embodiment of this aspect, the system can thereafter access a customer database that may include one or more of demographic information (e.g., gender, age, etc.), previous customer purchases and/or shopping patterns, and/or other personalized customer information. The system may also include, e.g., an advertising database. Using such a customer database and advertising database, the system preferably can select particular promotional offers, coupon offers, advertising, etc., that is appropriate for the customer and transmit such information to the movable display via the APs. While such “targeted” or “directed” offers and/or advertising can be provided to the movable display at any time, the system can also optionally select particular offers and advertisements based upon the particular location of the customer, as tracked by signals from either the movable display or the customer's loyalty token.

Optionally, upon association of the movable display with the customer, the server can automatically transmit a “welcoming” message to the movable display via the APs. The welcoming messages may, e.g., include a personal message to thank the customer for patronizing the store and/or a notification of current promotions. In further optional embodiments, the movable display may provide the customer with one or more options for assessing the customer database, including viewing previously stored shopping lists and/or previously stored electronic coupons (discussed below). The movable display may also include an “exit” or “log out” button that enables the customer to exit the system upon completion of the customer's shopping. Such exit or log out button may be separately provided, e.g., as a press button, or may be configured as a touch sensitive button on the display, e.g., an LCD display.

Because the present system is capable of tracking the movement of the customer and shopping cart or basket, the offers and/or advertisements optionally can be selectively displayed on the movable display when the cart or basket is moving.

In another aspect of the present teachings, the one or more wireless tags may comprise battery-powered, wireless electronic shelf labels (ESLs) that may be advantageously utilized to display product prices, minimize labor costs and/or provide virtual coupon offers. Such wireless ESLs may be utilized to reduce the facility cost of implementing incremental price changes, by enabling dynamic pricing algorithms to improve retail revenue and/or profits. Such wireless ESLs may also be advantageously utilized to minimize pricing discrepancies between the shelf and point of sale (POS) checkout in a retail setting.

In another aspect of the present teachings, the wireless system is preferably capable of generating ESL location information that may be used to deliver product or category specific marketing and promotion messages to consumers based on the detected position and/or velocity of the shopping cart and/or customer using signals transmitted by one or more of the wireless tags. In this aspect, the system may transmit the promotional offers, coupon offers and/or advertising to the ESLs, in addition or instead of the movable displays, when the system detects that the movable display and/or customer is in the vicinity of a particular ESL.

In a preferred embodiment of this aspect, the ESLs may include an input device, such as a button, touch pad, capacitive switch, etc., that may be advantageously utilized, e.g., for product stocking/re-stocking purposes. For example, upon activation of the input device, the ESL may transmit a signal to the APs, which signal indicates that the associated product requires replenishing or re-stocking on the retail shelf The server may then process the “out of stock” signal and send a message to an employee assessable display, thereby indicating that a certain product requires replenishment or restocking.

Various embodiments of this preferred embodiment are enabled by the present teachings. For example, the input device may be activated by a customer when the customer finds no products on the shelf and requests assistance. In addition or in the alternative, the input device may be utilized by authorized employees to quickly walk through the store and activate input devices for products that require replenishment. The server may then generate an itemized re-stocking list filtered by a back-store inventory database, thereby minimizing labor costs and relieving the employee from manually generating a replenishment list and checking it against the back-store inventory list.

In another embodiment, the ESL may display a “virtual” or electronic coupon offer for a predetermined period of time while the customer is located in the vicinity of the ESL, as determined by the system based upon the signals transmitted from the customer's loyalty token and/or movable display. The customer may then be encouraged to press the input device on the loyalty token in order to “capture” the virtual or electronic coupon for usage at the time of purchase. Preferably, the server stores the captured virtual or electronic coupons in the customer database, or another database, thereby minimizing the storage requirements of the loyalty token. However, it is to be understood that such virtual or electronic coupons also optionally may be stored in the loyalty token. In either case, when the customer arrives at the register, the system automatically deducts the value of the virtual or electronic coupon from the customer's invoice.

Optionally, the system may also be configured so that the customer can view captured or stored virtual coupons on the movable display, e.g., attached to the shopping cart or basket. In addition, the virtual coupons preferably may be stored for usage on a subsequent visit. For example, if the retail facility currently does not possess one or more items that are currently the subject of a promotion, the customer can preferably capture a “rain check” (i.e., an offer to purchase the item on a subsequent visit at the promotional price) by pressing the input device on the loyalty token. The server then stores the “rain check” for later usage. Naturally, the movable display optionally may be configured to display captured or stored “rain checks” upon demand by the customer.

Preferably, one or more of the above wireless tags, e.g., the loyalty token, the movable display and/or the ESL do not include local oscillator and are capable of entering a sleep mode when not in use. The wireless tag preferably “wakes up” periodically to check whether activation signals are being transmitted by the APs. When no activation signals are received, the wireless tag preferably returns to the sleep mode in order to conserve battery power.

For example, the loyalty tokens are preferably designed so as to enter a sleep mode when the customer exits the facility. The loyalty token may periodically wake up, e.g., every 20 seconds, to check for incoming activation signals. If an incoming activation signal is detected, the loyalty token may enter an active mode in order to periodically transmit signals, which can be triangulated to provide location information. If no incoming activation signal is detected, the loyalty token returns to the sleep mode.

Similarly, the movable displays may enter a sleep mode when the customer logs out and/or the server determines that the movable display is no longer in use. The power to the display itself, e.g., an LCD display, may be stopped to further conserve battery power. The movable display may periodically wake up to transmit a signal, which can be utilized to determine the location of the movable display and to check whether an “activate” signal has been transmitted. The system may continuously monitor the position of the movable display. If the system determines that the movable display has been moved by more than a predetermined distance, e.g., 1-5 meters, the system may transmit the activate signal to the movable display. The activate signal may, e.g., instruct the movable display to enter a fully activated mode, in which power is supplied to turn on the display itself. In the alternative, the activate signal may simply cause the movable display to transmit signals more frequently without powering up the display itself. If the system determines that the movable display has moved by more than a predetermined distance, and/or is moving at more than a predetermined velocity and/or a customer's loyalty token is moving in correlation with the movement of the movable display, the system may then transmit an activation signal to cause the display to power up and begin displaying information pertinent to the customer, as was described above (e.g., a welcoming message, a shopping list, promotional offers, an electronic coupon file, etc.)

The ESLs may be programmed to automatically shut down after business hours and to activate before business hours, so as to conserve battery power when the store or facility is not in operation. Alternatively, the system may send a global shut down signal that causes all wireless tags in the store or facility to enter the sleep mode at the same time. Then, the ESLs may periodically wake up to determine whether the system has transmitted a global wake up signal. If no global wake up signal is received, the ESLs may return to the sleep mode.

In another aspect of the present teachings, the system is preferably designed to provide various functions to the loyalty token depending upon the detected location of the loyalty token in the facility. For example, when the system determines that the loyalty token is in the vicinity of the register or cashier, the system can assess any virtual coupons that were captured by the customer and stored for later use. In this case, the cashier (or customer in a “self check out” system), e.g., scans the bar code of a product, and the register automatically deducts the value of the captured electronic coupon from the price, thereby eliminating the need for paper coupons and the labor necessary to manually enter discounts provided by paper coupons.

Optionally, the loyalty token may be configured so that the customer activates the input device at the register in order to supply the coupon information to the register. Alternatively, a bar code may be provided on an accessible surface of the loyalty token. In this optional case, the bar code may be scanned at the register in order to associate the customer's stored information in the customer database with the purchase and thus supply the coupon information to the register via the server.

In addition or in the alternative, the loyalty token may be advantageously utilized to take a number in a queue. In some retail establishments, during busy periods, a store employee may not be able to assist a customer on demand, such as in a delicatessen or other fresh food area. Therefore, many retail stores provide a number system, whereby the customer takes a number and waits for his/her turn to be served. However, in the present teachings, the customer may activate the input device of the loyalty token in the vicinity of such an area in order to “take a number” for the queue. Based upon the location information provided by the tracking features of the present teachings, the system can determine that the customer is in the vicinity of such an area and therefore, provide a virtual number to the customer. Consequently, the customer is not required to remain in that area until his/her number is called. Instead, the system may automatically cause the movable display to notify the customer, e.g., when his/her turn has arrived or provide a continuous indication of the number currently being service, so that the customer can return to the area to be served when his/her number is called. Therefore, the customer can utilize his/her shopping time more efficiently.

In addition or in the alternative, the loyalty token may optionally include audible or visual means for notifying the customer to return to the area. This feature may be useful for customers who do not take a cart or basket. For example, the loyalty token may include a sound generating means (e.g., a buzzer or speaker) that produces a sound or verbal notification to the customer. In addition or in the alternative, a light, such as an LED, may optionally flash to notify the customer or a display may be provided on the loyalty token to provide a text message.

In another aspect of the present teachings, the one or more wireless tags may be embodied as employee badges that may be carried or attached to a facility employee to provide additional useful functions. For example, employee badges may be utilized to provide employee location information using the location tracking features of the present teachings. In addition, employee badges may be utilized to provide authorization capability. For example, the system may be configured such that activation of the input device of an ESL while an employee badge is in the vicinity of the ESL provides additional information. In one preferred embodiment, such activation may enable the “out of stock” feature. In other words, the above-mentioned “out of stock” button on the ESL may only provide a valid “restock” message to the server when the server determines that an authorized employee is within a predetermined distance from the ESL, e.g., between 0-1 meter.

In another embodiment, activation of the ESL in the presence of the employee badge may be utilized to indicate that the product associated with the ESL has been re-stocked. A database in communication with the server may be updated to indicate the time when the re-stocking occurred. This restocking time information may then be utilized to assess the veracity of a later activation of the input device of the ESL. For example, activation of the input device of the ESL shortly after restocking took place may be deemed an inadvertent activation, such that the system does not send a message to re-stock that product.

Although various wireless protocols may be utilized to implement the various features of the present teachings, it is preferred that the wireless protocol provides sufficient spatial resolution to adequately track movement of the various types of wireless tags. Preferably, the system can spatially locate the wireless tags within 100 centimeters, more preferably within 50 centimeters and most preferably within 30 centimeters. Such spatial resolution enables the various associations to be reliably performed, e.g., virtual or electronic coupon capturing, movable display-loyalty token association, downloading coupons to the register, taking numbers for queues, ESL authorization, etc.

In another aspect of the present teachings, transmissions from wireless tags to APs optionally may be based upon an impulse radio protocol. Optionally, transmissions from APs to wireless tags may be narrowband. In addition or in the alternative, the system preferably can maintain simultaneous communications with a plurality of wireless tags. In addition or in the alternative, the wireless tags preferably initiate data communications with the APs. For example, upon waking up from a sleep mode, the wireless tag may search for a beacon signal, which may be constantly or intermittently transmitted, in order to synchronize a phase lock loop (PLL). Upon locking onto the beacon signal, the wireless tag may immediately transmit a data payload. Therefore, multiple wireless tags may simultaneously transmit signals to the APs without waiting for an instruction from one or more APs.

Further objects, aspects and advantages of the present teachings will be readily understood after reading the following description with reference to the drawings and the appended claims.

### BRIEF DESCRIPTION OF THE DRAWINGS

FIG. 1 shows a representative network for communicating with a mobile wireless tag, which network includes a plurality of wireless access points in communication with each other, wireless tags and a central server.

FIG. 2 shows a representative block diagram of a wireless tag.

FIG. 3 shows a representative electronic shelf label (ESL).

FIG. 4 shows a representative wireless enabled shopping cart handlebar.

FIG. 5 shows a representative loyalty token.

FIG. 6 shows a representative block diagram of server application software programs and their associated databases.

FIG. 7 shows a representative loyalty token with an LED indicator and printed circuit board (PCB) detail.

FIG. 8 shows a representative ESL with a hinged promotional sign.

### GLOSSARY OF TERMS

The following abbreviations are utilized in the present description, which abbreviations are intended to have the meanings provided as follows:
AP—wireless access point
CPG—consumer packaged goods
ESL—electronic shelf label
FCC—U.S. Federal Communications Commission
IC—integrated circuit
ID—identification code key
IEEE 802.11, 802.15—wireless standards
ISM—industrial, scientific and medical wireless band
LAN—local area network
LCD—liquid crystal display
LED—light emitting diode
OLED—organic LED
PCB—printed circuit board
PDA—personal digital assistant
PLED—polymer LED
PLL—phase locked loop
POS—point of sale
RFID—radio frequency identification device
Rx—receive
TCP/IP—transmission control protocol/internet protocol
Tx—transmit
UWB—ultra wide band

### DETAILED DESCRIPTION OF THE INVENTION

Each of the additional features and teachings disclosed below may be utilized separately or in conjunction with other features and teachings to provide improved wireless systems and methods for designing and using the same. Representative examples of the present invention, which examples utilize many of these additional features and teachings both separately and in combination, will now be described in further detail with reference to the attached drawings. This detailed description is merely intended to teach a person of skill in the art further details for practicing preferred aspects of the present teachings and is not intended to limit the scope of the invention. Therefore, combinations of features and steps disclosed in the following detail description may not be necessary to practice the invention in the broadest sense, and are instead taught merely to particularly describe representative examples of the present teachings.

Moreover, the various features of the representative examples and the dependent claims may be combined in ways that are not specifically and explicitly enumerated in order to provide additional useful embodiments of the present teachings. In addition, it is expressly noted that all features disclosed in the description and/or the claims are intended to be disclosed separately and independently from each other for the purpose of original disclosure, as well as for the purpose of restricting the claimed subject matter independent of the compositions of the features in the embodiments and/or the claims. It is also expressly noted that all value ranges or indications of groups of entities disclose every possible intermediate value or intermediate entity for the purpose of original disclosure, as well as for the purpose of restricting the claimed subject matter.

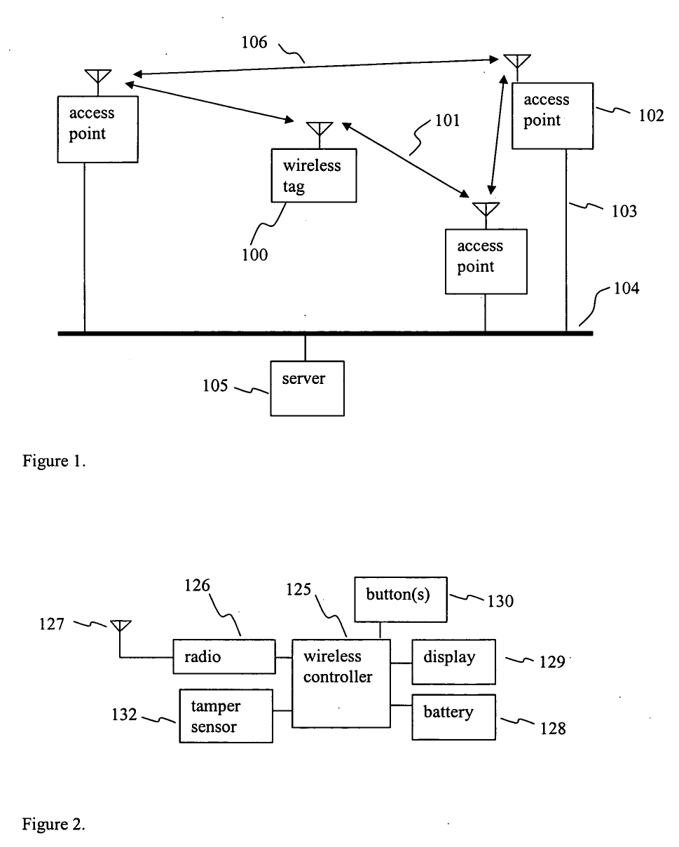

In one embodiment of the present teachings, shown in FIG. 1, a wireless system preferably may include one or more wireless access points 102, which are connected to one or more servers 105 via a wired and/or wireless data network (e.g., a LAN) 104. One or more wireless tags 100 preferably communicate with the wireless access point(s) 102 via a wireless communication channel 101. Representative features that may be commonly implemented in the various types of wireless tags contemplated by the present teachings, including but not limited to loyalty tokens, ESLs, movable displays, employee badges, and/or tags affixed to shopping carts, shopping baskets, handheld scanners, point-of-sale devices, etc., will first be described with a common example of a preferred wireless tag. Thereafter, features and functions specific to the various types of wireless tags will be described in further detail.

The wireless access points 102 may directly communicate with each other via wireless links 106, for example, to synchronize and calibrate a positioning function, as will be discussed further below. Access points 102 are connected to the network 104 via a wired and/or wireless communications channel 103. Thus, access point(s) 102 and server(s) 105 preferably can communicate with each other via the network 104.

Naturally, while only one wireless tag 100, three access points 102 and one server 105 are shown in FIG. 1 for the purpose of providing an easy to understand illustration, naturally more or less of each devices may be advantageously utilized depending upon system requirements and the particular application of the present teachings.

Preferably, at least one, several or all of the wired or wireless channel(s) 101, 106, 103 may be encrypted. In other words, the data transmitted via the wired and/or wireless channels 101, 106, 103 may be encoded using known encryption algorithms in order to increase the security of the transmitted data.

The wireless tag(s) 100 optionally may aggregate outgoing (transmitted) data in a local data storage or memory that is provide either within the controller 125 or separately. Then, the data may be transmitted in bursts in order to improve the quality of the communication link and the power efficiency of the system, as will be discussed below. In addition, the transmission power of the wireless tag(s) 100 preferably can be modulated or adjusted using commands or instructions generated by the access points 102 and/or the server 105 in order to reduce interference and/or increase network capacity.

In another embodiment, the wireless tag 100 may be designed to send or transmit a pre-assigned ID code key, optional status data concerning the state of the wireless tag 100, such as from a button or sensor or a detected battery level, and/or radio transmit or receive parameters, such as received signal strength. This information may be transmitted via the wireless channel 101 to one or more access points 102 either alone or in combination with other information, signals, data, commands, etc.

In addition, the wireless tag 100 may receive information from one or more access points 102 via the wireless channel 101. This information may include, e.g., one or more of target transmit power level, indicator commands, status queries, and/or additional information, such as display data, marketing data, etc.

Herein, the term “display” or “displays” is intended to encompass any visual means of communicating the state of the system, e.g., by text and/or symbols and/or numbers, to a person. Representative examples of suitable displays include, but are not limited to, LCDs, LEDs, OLEDs, PLEDs, plasma or any other light emitting or modulating mechanism.

Further, the term “button” or “buttons” is intended to encompass any type of electrical switches, capacitive touch sensors, magnetic sensors, optically activated inputs or any other input mechanism or sensor that may be manipulated by a person. In other words, the term “button” is intended to encompass a wide variety of known data input devices that may be utilized, e.g., by customers, staff, maintenance personnel, etc. Multiple input commands optionally may be encoded on one or more input buttons by following a prescribed or predetermined sequence. For example, a representative prescribed sequence (method) may include, e.g., tapping (pressing) on the button one, two or three times in order to activate a particular mode/function of the wireless tag 100.

Herein, the term “sensor” or “sensors” is intended to encompass any device capable of sensing a quantity, parameter, condition and/or state, such as temperature, battery level, illumination, motion, humidity, airflow, carbon monoxide levels, water level, water pressure, air pressure, mechanical strain, etc. In addition, the term “sensor” or “sensors” is also intended to encompas devices such as electronic imaging devices such as CMOS camera sensors or CCD imagers.

In addition, the term “battery” is intended to encompass any type of portable electrical power source, control or storage means, such as button cells (e.g., watch batteries), lithium batteries, silver chloride batteries, zinc chloride batteries, carbon zinc batteries, nickel cadmium batteries, nickel metal hydride batteries, lithium-ion batteries, polymer-based batteries, alkaline batteries, fuel cells, capacitors, solar cells, vibration converters, thermal power generators or laminated chemical batteries.

Moreover, the term “controller” is intended to encompass processors, such as microprocessors, electronic control devices, state machines and other circuits that may be utilized to electronically control the operation of other circuit elements. In addition, the present controllers may be connected to, or may incorporate therein, memory or storage for storing one or more control programs that are executed by the controller.

The term “server” is intended to encompass any computing device(s) that is (are) capable of controlling and monitoring the network 104, receiving signals from the access points 102 and transmitting signals to one or more wireless tracking devices 100 via the access points 102. The server 105 preferably includes one or more processors or controllers in communication with memory or storage means. The memory or storage means may store one or more control programs for operating and/or administering the server 105 and the network 104, including some or all components within the network 104. In addition, the memory or storage means may store various information including but not limited to customer profile data, product information, product pricing, promotional messages, wireless tag 100 parameters, etc. This information can be accessed for use with the various wireless tags 100 disclosed herein, as further discussed below. Two or more servers 105 may be utilized in combination, as system requirements will determine the specific design and functions that are appropriate for the server(s) 105. For example, a first memory or storage means may store the control program(s) and a second memory or storage means may store other useful information and data, such as the consumer related data, such as e.g., demographic information and other stored information such as stored coupons, rain checks, shopping lists, etc. A third memory or storage means may optionally store, e.g., advertising information. Naturally, one or more of these memory or storage means may be combined. The server(s) 105 is (are) preferably capable of accessing such information, even if such information is, e.g., stored on separate server(s) 105.

The control programs executed by the server 105 preferentially generate, assign, store, compare and/or validate the ID code keys and operational parameters such as sleep time of the wireless tags 100 and access points 102.

FIG. 2 shows a representative block diagram of a representative wireless tag 100 according to the present teachings. The representative wireless tag 100 shown in FIG. 2 preferably may include one or more of the following features: one or more wireless controller ICs 125 (optionally including one or more memory or storage devices), a bi-directional radio 126, an antenna 127, a battery 128, an optional display 129, one or more optional buttons 130, and/or a tamper sensor 132 or other optional devices, such as one or more other sensors (not shown).

As used herein, the term “radio” is intended to mean a wireless transceiver, i.e., a device capable of transmitting wireless or radio signals and receiving wireless or radio signals. Representative wireless communication tranceivers include, but are not limited to, Ultra Wideband (UWB) radios (e.g. IEEE 802.15.3a, IEEE 802.15.4a, Multispectral Solutions PAL650 system), wireless LAN (e.g. 802.11a/b/g), wireless Personal Area Networks (PAN) (e.g. 802.15.1, Bluetooth), low data rate radios (e.g. 802.15.4, ZigBee, Wireless USB), Global Positioning System (GPS) radios, cell phone radios, television signals, AM and FM radios, cordless phone radios (e.g. DECT), Real Time Location System radios (e.g. ANSI-371, WhereNet, Inc., Savi Technologies, Inc.), infrared communication systems and RFID radios (e.g. EPC Class 1 version 2). In the present invention a low power radio with accurate location capability is preferred although higher power or less accurate positioning systems are sufficient to implement the present teachings.

The battery or power source 128 preferably supplies power to the wireless controller 125 and the radio 126 communicates information to and from the wireless controller 125. One or more displays 129 optionally can be connected to the wireless controller 125 to provide visual notifications. One or more input devices (e.g., buttons) 130 optionally may communicate with the wireless controller 125 in order to provide input signals to the wireless controller 125.

The wireless tag 100 is preferentially designed to continuously or intermittently transmit signals, which are preferably received by at least three (3) wireless access points 102, so that the server 105 can accurately derive or determine position or location information for the wireless tag 100 based on relative signal time-of-arrival or code phase measurements at each access point 102. Additional or alternative position information may also be determined with one, two or more wireless access points 102 based on, e.g., received signal strength and/or direction-of-arrival. The present teachings can be suitably modified in this regard based upon system requirements and the particular application of the present teachings.

The position information derived by the server 105 may be continuously stored in a database on one or more servers 105.

In addition or in the alternative, if the location and status information of the wireless tag 100, as determined by the server 105, is displayed on one or more display terminals, maintenance personnel may, e.g., quickly be alerted to a broken or malfunctioning wireless tag 100 with location information. Moreover, the location/status information may be utilized simply for the purpose of identifying the location of various wireless tags 100 for various uses, as will be apparent from the present teachings.

In a preferred embodiment, each wireless tag 100 is assigned a unique ID code key (e.g. a 24 bit binary word although other bit lengths may be used as applicable). The unique ID code keys are used to discriminate between messages to/from other wireless tags 100 or APs 102. Persons skilled in the art will recognize that various other encoding and/or identification schemes may be utilized with the present teachings depending upon the particular application of the present teachings.

The wireless tag 100 may optionally transmit the state of one or more optional buttons and/or sensors 130 via the wireless link(s) 101. The wireless access point(s) 102 may forward the received information concerning the button and/or sensor status (i.e., the inputted data) to the server 105. Thereafter, the server 105 may communicate this information to one or more other networked devices or applications.

In another example, a wireless tag 100 may optionally include a tamper sensor 132. If the wireless tag 100 is inappropriately removed from its mount as detected by the tamper sensor 132, the wireless tag 100 can transmit a tamper indication to the server 105 which receives the information and preferably transmits a tamper indication to the nearest staff and/or security personnel.

Wireless tag 100 preferably includes a radio 126 capable of long range, low power data communications with a position determination function. In one embodiment, APs 102 provide one or more precise timing beacons over wireless communication channel 101 which wireless tags 100 use to synchronize their local oscillators, permitting synchronous communications that allow for significant processing gain and noise removal trhough synchronous signal averaging and/or decoding. In addition or in the alternative, radios 126 capable of rapidly acquiring and synchronizing with timing signals from one or more APs 102 to enable low data rate communications are preferred in the present teachings as they allow for reduced power and longer range while minimizing tag 100 cost.

The wired or wireless communication channels 103 and the network 104 preferably may communicate using standard TCP/IP protocols via a wired LAN or one or more wireless LANs. Representative examples of wireless LANs that may be advantageously utilized with the present teachings, include e.g., the standards IEEE 802.11a, 802.11b, 802.11g and their derivatives or extensions, all of which are incorporated herein by reference.

The wireless channels 101, 106 may be based on a known communication standard, such as IEEE 802.11 and 802.15 families of standards, including but not limited to 802.11a, 802.11b, 802.11g, 802.15.1, 802.15.3, 802.15.3a, and 802.15.4, 802.15.4a and ANSI-371 which standard protocols are incorporated herein by reference.

In addition or in the alternative, the wireless channel 101 may be based upon a low data rate multiple access UWB impulse radio protocol described herein and in U.S. application Ser. No. 11/119,340, filed Apr. 28, 2005, which claims the benefit of U.S. provisional patent application No. 60/565,989, U.S. application Ser. No. 11/156,193, filed Jun. 16, 2005, which claims the benefit of U.S. provisional patent application No. 60/582,888, U.S. patent application Ser. No. 11/155,125, filed Jun. 16, 2005, which claims the benefit of U.S. provisional patent applications Nos. 60/580,678 and 60/605,568, the contents of which are incorporated herein by reference.

In operation, the wireless tag 100 preferably transmits one or more signals that are received by one or more wireless access points 102. Based upon the measured relative time-of-arrival, relative signal strength, direction of arrival, and/or the multipath signature information received at each receiving wireless access point 102, the location of the tag can be determined by the central server 105. Various techniques, algorithms and programs for “triangulating” or determining the position or location of a tracked tag 100 using signal information received from the tag 100 by one or more non-coplanar wireless access points 102 are known in the art and need not be described herein in detail.

In one embodiment of the present teachings, access point 102 to tag 100 communication link 101 is in the UNII sub-band from 5.47 GHz to 5.725 GHz with a variable channel bandwidth of 20 MHz to 200 MHz. In a further embodiment, the link 101 from tag 100 to access point 102 (i.e., the return path) is in the UWB band centered at 4.2 GHz. The particular frequencies and bands are application dependent and the present teachings are not particularly limited in this regard.

UWB pulsed radios can substantially decrease the power consumption of the wireless tag 100 while enabling an accurate measurement of the pulse time-of-arrival. Consequently, accurate location determination by triangulation is possible. Other radio protocols permit location determination by similar time-of-arrival triangulation or other means known in the art such as signal strength proximity measurements and/or direction-of-arrival measurements. In the preferred embodiment of the present teachings, a previously unattained operating point in radio protocols is provided, which combines ultra low power, ultra low cost, long range, high precision location determination and a high (e.g. 100 k+) number of wireless tags 100 in a single installation. These features make the present teachings particularly commercial viability. However, one skilled in the art will understand that any position-sensitive two way radio may be substituted if one or more of the above-noted features is not a constraint of the particular application. Moreover, such features are not a necessity of all aspects of the present teachings. Therefore, the system level aspects of the present teachings, discussed below, are not restricted by the choice of particular location capable radio; i.e. the present teachings are not particularly limited by the choice of location capable wireless protocol, although the present teachings enable a highly advantageous implementation of such a wireless protocol as described above.

As will be discussed further below, the baseline wireless tag 100 may be encapsulated in many forms according to the present teachings, including but not limited to ESLs, movable (e.g., shopping cart) displays, kiosks, key chains, smart cards, security tokens, end cap displays, promotional displays, projection displays, loyalty tokens, badges, asset tracking tags, RFIDs, voice headsets, cell phones, point-of-sale (POS) devices, temperature sensors, light switches, light detectors, electronic cameras, motion detectors, out-of-stock detectors, infrared communications equipment, WLAN communication equipment, mobile computers, watches, jewelry, toys, pallets, cases, totes, products for sale, USB peripherals, etc. The present teachings are not particularly limited with respect to the number, type or form of the wireless tags 100 that may be utilized unless specifically stated.

First, various representative examples of the wireless tag 100, which may be used alone or in combination, will be briefly described and then a representative wireless system incorporating one or more of these wireless tags 100 will be further described.

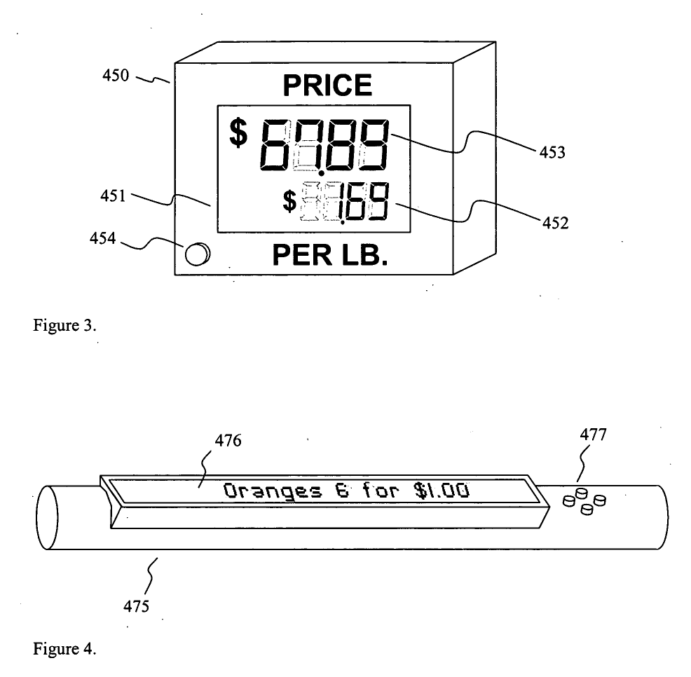

In one representative embodiment of the wireless tag 100 according to the present teachings, FIG. 3 shows a representative electronic shelf label (ESL) 450 that optionally may include one or more of the following additional features: a display 451, which may be capable of displaying a price 453 and a unit price 452, as well as one or more buttons 454. The display 451 and button(s) 454 are in communication with the controller 125. The scope of the terms “display” and “buttons” was defined above.

In another embodiment of the wireless tag 100 according to the present teachings, FIG. 4 shows a representative shopping cart handlebar 475 that optionally may include one or more of the following additional features: a display 476 and one or more buttons 477, both of which are in communication with the controller 125.

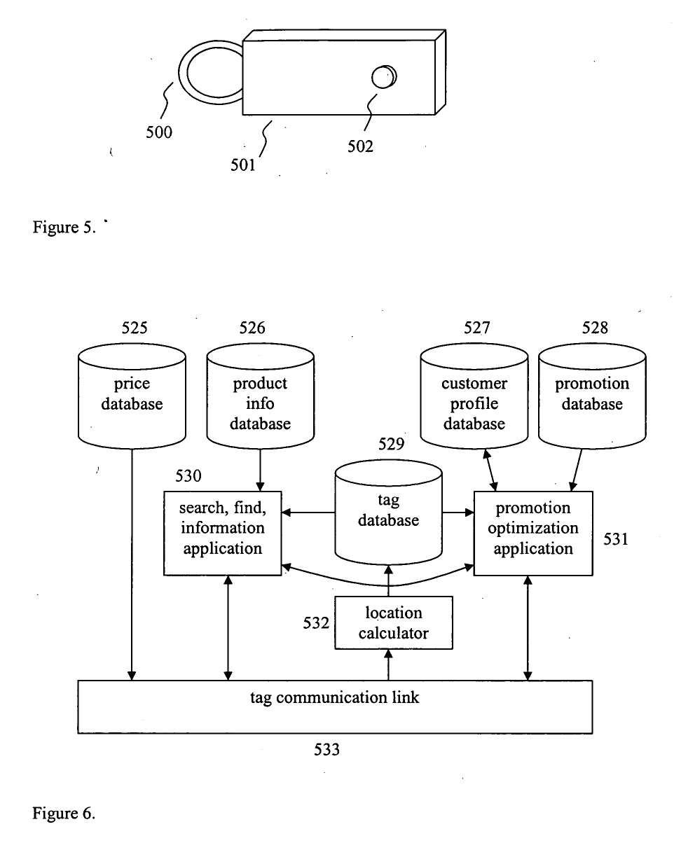

In another embodiment of the wireless tag 100 according to the present teachings, FIG. 5 shows a representative loyalty token 501 that optionally may include one or more of the following additional features: an attachment point 500 and one or more buttons 502. The button(s) 502 is (are) in communication with the controller 125.

The term “loyalty token” is intended to encompass any device that is given or assigned to consumers which allows them to participate in a retailer's affinity, frequent shopper or loyalty program. The choice of physical embodiment of the loyalty token, whether a key chain, card, jewelry, flashlight, coin, bracelet, necklace, or toy, or as an embedded device within other devices (such as a cell phone or PDA), is not particularly limited in the present teachings.

In another embodiment of the wireless tag 100 according to the present teachings, a free standing display kiosk or mobile display may be provided to allow user access to the network.

One or more of these wireless tag types can preferentially be used to provide enhanced automation for store processes, convenient access to information for consumers and/or a new channel for promotional messages, among other things. In one embodiment of the present teachings, one or more servers 105 implements the software architecture shown in FIG. 6, which software architecture may preferably comprise one or more of: a price database 525, a product information database 526, a user profile database 527, a promotion database 528, a tag database 529, a search, find and information software application 530, a promotion optimization software application 531, a location calculation software application 532 and a tag communication link 533. In one embodiment of the present invention, the tag database 529 may optionally contain the following data: tag location, battery life, button status, velocity vector, sleep time, received signal strength, one or more ID codes, stock status, replenishment data, pointers to other databases, wireless coding parameters, diagnostic information, etc.

In one representative embodiment, pricing information is transmitted from the pricing database 525 (server 105) via one or more access points 102 to one or more ESLs 450. The ESL 450 then displays the price information on its display 451.

In another embodiment of the present invention, the time-of-arrival signal information of the wireless tag 100 is measured at one or more access points 102 and collected by server 105. The location calculator application 532 calculates precise 3D location of the wireless tag 100 based on the relative time-of-arrival of the signal from the wireless tag 100 and the calibrated time/space relationship of the one or more access points 102 to each other and/or site landmarks. The calculated location information is stored within the tag database 529. In addition or in the alternative, spatial calibration wireless tags 100 with known physical positions relative to the store layout can be placed and programmed to provide reference locations for the calibration of the triangulation calculation. In addition or in the alternative, signal strength, signal direction and/or time-of-arrival may be used to determine the location or approximate location of wireless tags 100.

In another preferred embodiment of the present invention, an ESL button 454 can be configured as an out-of-stock (OOS) input device. Consumers and/or employees can be encouraged to push the OOS button 454 if they notice that the corresponding item is out-of-stock (i.e., not on the shelf next to the corresponding ESL 450. Such information can be used to improve the efficiency or accuracy of reordering and/or replenishment activity.

The OOS feature of ESL 450 may be implemented in various ways. For example, in one embodiment, the OOS button 454 may be activated (e.g., pressed), thereby causing the controller 125 to generate an “out-of-stock” message, which is transmitted via the radio transceiver 126 and antenna 127 to the access points 102. The activation of the OOS button 454 may cause the ESL 450 to wake up from a sleep mode and begin searching for a beacon signal from one or more access points 102, in order to begin a communication session as was described above. In the alternative, the sleep mode of the ESL 450 may be sufficiently short during facility operation hours that activation of the button 454 will be sensed without interruption of the sleep mode. In the resulting communication session, the out-of-stock message is transmitted to the server 105 via one or more access points 102. The server 105 then transmits the out of stock message to an employee notification device, such as a display.

The server 105 may also store information concerning the most recent re-stocking of the item. In this case, when an out-of-stock message is received, the server 105 may check when the last re-stocking took place in order to access the veracity of the out-of-stock message. For example, if the items were recently re-stocked, the out-of-stock may be disregarded. The parameters for determining the validity of an out-of-stock message can be determined based upon the particular application, the type of retail facility, the amount of sales of the particular item, seasonal factors, etc.

In addition or in the alternative, the server 105 may determine that the out-of-stock message from the ESL 450 is valid only when another wireless tag 100 is determined to be within the vicinity of the ESL 450 when the button 454 was activated. For example, the present wireless tags 100 may be embodied as an employee badge. In this case, when the server 105 receives the out-of-stock message via the one or more access points 102, the server 105 may determine whether an employee badge 100 is located within the vicinity, e.g., 1 meter, of the ESL 450 when the button 454 was activated. The server 105 optionally may determine the location of the employee badge 100 using the above-described tracking (triangulation) techniques.

If no employee badge 100 is located sufficiently close to the ESL 450, the server 105 may disregard the out-of-stock message as being an inadvertent activation of the button 454. In this embodiment, the system may be utilized to enable an employee to quickly walk through the retail facility and activate buttons 454 for items that require stocking. The server 105 may automatically validate all such out-of-stock messages as being from an authorized source, and then compile a list of items that require re-stocking. Thus, the employee is not required to prepare a list for re-stocking purposes, thereby improving store efficiency.

In addition or in the alternative, the server 105 may disregard a received out-of-stock message if a loyalty token 501 and/or a movable display 475 is located within the vicinity of the ESL 450 when the button 454 was activated. This feature may be utilized to distinguish out-of-stock messages generated by adult shoppers, and minimize inadvertent out-of-stock messages that may have been caused by a child activating the button 454.

In addition or the alternative, the ESL 450 may be configured to easily record when re-stocking took place. In this optional embodiment, the button 454 may be configured such that a different activation protocol may be utilized to generate a “item re-stocked” message. For example, “out-of-stock” messages may be generated upon a single activation (e.g., press or tap) of the button 454, whereas “item re-stocked” messages may be generated upon a double activation (e.g., two presses or taps) within a predetermined period of time. In the alternative, a second button 454 may be provided for generating “item re-stocked” messages.

According to this optional feature of the ESL 450, when an employee completes re-stocking an item, the employee may activate the button 454 to generate an “item re-stocked” message. The server 105 may then utilize this information to update a database to record the time of the last re-stocking of each item in the store. This information then may be utilized to determine whether subsequent “out-of-stock” messages are valid, as was discussed above.

Optionally, the server 105 may only validate a received “item re-stocked” message if an employee badge 100 is determined to have been within the vicinity, e.g., 1 meter, of the ESL 450 when the button 454 was activated. Thus, this feature can be utilized such that only authorized personal can transmit valid “item re-stocked” messages. Again, the system may utilize the above-described tracking (triangulation) techniques to determine whether the employee badge 100 is located sufficiently close to the ESL 450 when the “item re-stocked” message was transmitted in order to confirm the validity of the message. This feature enables the system to automatically record re-stocking activities with time information, thereby improving the efficiency of store employees.

As will be appreciated, the out-of-stock feature of the ESLs 450 of the present teachings may be modified in various ways depending upon system requirements.

In a further embodiment of the present teachings, the tag database 529 information can be used to locate a malfunctioning tag 100 or a tag 100 that represents an out of stock product to aid maintenance and upkeep personnel.

For example, wireless tags 100 contain sensors (not shown) for detecting and measuring the battery charge status, display status, button status, wireless signal strength, interferer status, temperature, tampering or other tag conditions that can be relayed to the server 105 via access points 102. For example, ESLs 450 can be configured to transmit messages, as appropriate, to notify the server 105 that the ESL 450 requires attention for one or more of these reasons. In addition, diagnostic or maintenance applications executed by the server 105 optionally may automatically generate reports for managers and maintenance personnel.

In another embodiment of the present teachings, the tag location information stored in the tag database 529 can be compared to a store plan-o-gram or schematic layout to measure store compliance with desired product positioning.

In a further embodiment of the present teachings, the tag location information can be used as trade promotion verification data for CPG companies.

In another embodiment of the present teachings, the server 105 can recognize if a wireless tag 100 failed to check in at the designated time. This information can be used to identify missing, removed or damaged tags, which is currently a large source of persistent out-of-stock conditions.

In another embodiment of the present teachings, the server 105 can generate a security alert if a wireless tag 100 is removed from the premises or is tampered with, as sensed by one or more tamper detection sensors (132) in or on the wireless tag 100. Such a security alert may be used to quickly locate the time and position of a device theft or tamper incident, thereby allowing rapid indexing and searching of security camera footage.

In another embodiment of the present teachings, replenishment data can be displayed at the ESL 450 to aid restocking activities, such as number of facings.

In another embodiment of the present teachings, a low cost promotional flag that is clipped onto an ESL 450 can be used to draw attention to promotional items. ESLs 450 can be made to flash (e.g., display 451 or another visual means) by the server 105 to indicate to staff which ESLs 450 require the clip-on promotional flag to significantly simplify and speed up the promotion deployment. In a further embodiment, the ESLs 450 can flash different messages or codes to specify one of a class of clip-on promotional messages (e.g. buy 1 get 1 free, 2 for $3, club price, etc.).

In another embodiment, the location or position of the wireless display 476, mounted on shopping cart handlebar 475 (FIG. 4) may be determined by the location calculator 532 (FIG. 6) and the location information may be stored in the tag database 529. Thereafter, this location information can be used to select an appropriate marketing (promotional or advertising) message by the promotion optimization application 531 to be transmitted to and displayed on the display 476. In one embodiment of the present teachings, the promotion optimization application 531 selects appropriate promotional messages stored in database 528, based upon the location of the display 476 and/or loyalty token 501 (FIG. 5) in relation to one or more ESLs 450, to deliver to the consumer. Location information concerning the ESLs 450 preferably is stored in tag database 529. Thus, as the customer walks through the store, the system automatically tracks the movement of the customer and can display promotional messages on a close ESL 450 and/or on the movable display 476. Naturally, the promotional messages may be selected so that promotions concerning items currently located in the vicinity of the moving customer are displayed.

As indicated by the above-description, the present systems are capable of automatically determining and storing the locations of the various ESLs 450 disposed in the facility. One advantage of tracking ESL location is that any subsequent changes to product location (e.g. setting up end caps, promotional displays, aisle/category resets, etc.) are automatically captured and stored in the tag database 529 with no human intervention or re-measuring by retail staff, thereby reducing errors and labor when items in a store are moved to a different area.

In another embodiment, the server 105 may generate and store customer movement information by tracking movement of the shopping cart handlebar 475. This customer movement information can then be analyzed to optimize store layout, product promotions, etc. In a further embodiment, a wireless tag 100 is embedded within shopping baskets as well to capture consumer traffic (movement) data.

In another embodiment, the handlebar display 476 can provide alternative product information on the currently displayed/promoted product when a button 477 is pressed. The appropriate data can be selected from the product information database 526 and transmitted for display on the handlebar display 476.

In another embodiment, the location of a particular item or product can be displayed by activating button 477. Thus, the customer can utilize the handlebar display 476 to find items or products in the store. Optionally, the server 105 may also calculate a route to the selected product location and display direction instructions (e.g. turn left, go to aisle 3) on the handlebar display 476 to guide the consumer to the requested product.

In another embodiment, an index or menu may be provided on the handlebar display 476 which allows a consumer to efficiently enter a product category. Thereafter, the system can subsequently guide the consumer to product by displaying direction information on the display as described above.

In another embodiment, the location history of the cart handlebar 475 can be analyzed to estimate the interests, profile and current basket contents of the consumer to optimize further messages. For example, if the customer (as determined by location information from the cart display 476 or the loyalty token 501) stops in front of the milk section for e.g. 20 seconds, the promotion optimization application 531 can decide to promote, e.g., breakfast cereal if the consumer has not yet gone to the breakfast cereal aisle.

In another embodiment, the promotion optimization application 531 may optionally deliver new promotional messages to the consumer only when the cart handlebar 475 is moving to increase the likelihood that the customer will be in a position to view the cart handlebar display 476 when the promotional message is displayed. When the server 105 determines that the handlebar 475 is not moving based upon the tracking information, no or fewer promotional messages may be transmitted to the display 476, because the customer may have left the shopping cart to find an item and therefore, would not be in a position to see the promotional message. In addition or in the alternative, a touch sensor (not shown) can be provided on the handlebar 475 for determining whether the consumer has their hands on the cart handlebar 475. When the touch sensor is activated, it is likely that the customer is pushing the cart and will likely see the displayed message. The touch sensor information naturally can be transmitted to the server 105 and utilized by the promotion optimization application 531 to select appropriate messages for display on the display 476.

In another embodiment, the location and motion of the cart handlebar 475 can be analyzed by the server 105 to provide a power down signal for the handlebar circuitry (e.g. display 476) in order to conserve battery power. For example, if the cart is in a return area in the parking lot or in a cart storage area within the facility, the server 105 may cause a “power down” or sleep mode signal to be transmitted to the display 476. In addition or in the alternative, cart handlebar circuits can be powered down depending on the time of day (e.g. turned off during non-business hours). For example, the server 105 may send a global “power down” or sleep mode signal to all wireless tags 100 (e.g., displays 476 and ESLs 450) when the store business hours have ended. The wireless tags 100 may then utilize extended sleep periods when it is not likely that an activation signal would be received. Before the beginning of store business hours, the server 105 may transmit a global wake up signal to all wireless tags 100. When the various wireless tags 100 randomly wake up from their respective sleep modes and acquire the beacon signal, the wake up signal may then be transmitted, thereby causing the wireless tags 100 to shorten their respective sleep periods.

In another embodiment, the loyalty token 501 is used to automatically associate a shopping cart with a consumer's loyalty profile database record. The server 105 tracks the location of both consumers and carts, and identifies correlations between cart and consumer position and movement. If the correlation of cart and consumer persists beyond some threshold, the system can reliably assume that a particular cart is being used by a particular consumer carrying a loyalty token 501. The cart-customer association may be performed in various ways depending upon the application of the present teachings. In one representative example, the customer may be given the loyalty token 501 to carry. When the customer goes to the store, the loyalty token 501 will come within transmission range of one or more APs 102. Loyalty token 501 wakes up from a low power sleep mode either by timer expiration (e.g. check for AP signal every 2 minutes) or by receiving a signal from one or more APs 102. Upon acquiring the AP 102 signal, the loyalty token 501 transmits at least the unique customer identification information stored in the loyalty token 501. Upon receiving the unique customer identification information, the server 105 accesses the customer profile database 527 and “logs” the customer into the system. Thereafter, the server 105 may instruct the loyalty token 501 to shorten its sleep mode periods so as to track movement of the loyalty token 501 throughout the store more frequently.

If the customer selects a shopping cart or basket with a movable display 476 (or other wireless tag 100 device as described above), the server 105 also tracks movement of the shopping cart or basket via signals transmitted from the movable display's 476 radio. Based upon correlations between the tracked movements of the display 476 and the loyalty token 501, the server 105 may associate the display 476 with the loyalty token 501. The particular threshold for determining a correlation between the tracked movements of the display 476 and loyalty token 501 may be determined based upon system requirements, and may include e.g., proximity of the display and loyalty token 501, substantially similar velocities of movement of the display 476 and the loyalty token 501 for a predetermined period of time, etc. The present teachings are not particularly limited with regard to how the correlation and association are performed.

After the display 476 has been associated with the loyalty token 501, the server 105 may utilize the promotion optimization application 531 to access the customer profile database 527, as well as the promotion database 528, in order to generate appropriate messages to be transmitted to and displayed on the display 476. For example, when the display 476 is first associated with the loyalty token 501, the customer profile database 527 may be accessed using the unique customer identification code transmitted by the loyalty token 501 to cause the display 476 to display a welcoming message. For example, the display 476 may welcome the customer by name and thank the customer for his/her patronage.

Thereafter, the promotion optimization application 531 may access past shopping history, demographic information, etc. stored in the customer profile database 527 in order to select appropriate promotional messages from the promotion database 528 for that particular customer. Thus, the present teachings enable the system to send targeted messages to the customer, thereby increasing the likelihood that the customer will find the promotional message to be relevant. If particularly relevant messages are displayed, the likelihood is increased that the customer will read the displayed information and consider his/her purchasing options based upon the displayed promotional messages.

Because the present system can recognize a particular customer, utilize previously stored customer specific information and associate a display 476 with that particular customer, customer-relevant promotional messages can be displayed on the display 476 at any time. Thus, the present system provides a highly advantageous platform for targeted advertising.

In addition, because the server 105 is capable of tracking the customer's movement through the store, via the display 476 and/or the loyalty token 501, promotional messages can also be selected based upon the customer's present location within the store. Thus, if the customer profile database 527 stores information that the customer typically purchases a particular brand of a product, when the customer arrives in the store area where that product is stocked (located), the server 105 can transmit to the display 476 a selected promotional message concerning the customer's preferred brand.

Naturally, various strategies for selecting promotional messages are enabled by the present teachings, and the present teachings are not limited to any particular selection strategies.

In another embodiment, the promotion database 528 is generated using an online marketplace for message placement. For example, CPG brand managers make bids for advertising to particular demographics, geographic regions, etc. over a period of time for particular stores and particular products or product categories.

In another embodiment, the button 477 of the display 476 and/or the button 502 of the loyalty token 501 may be configured to capture virtual or electronic coupons, or extended sale or rain-check for the case where a consumer likes a promotion but would prefer to defer the purchase. In the case of virtual or electronic coupons, the display 476 and/or ESL 450 and/or another display may display a discount promotion (i.e., a coupon) and encourage the customer to press the button 477 and/or 502 in order to capture that coupon for later usage. The server 105 may determine when and how to display such electronic coupons based upon one or more of customer demographics, customer purchasing history, customer location within the store, etc. If the customer presses the button 477 and/or 502 within a predetermined period of time and/or within the vicinity of the displayed electronic coupon offer, the server 105 stores the captured electronic coupon in the customer profile database 527. Then, when the customer arrives at the register (cashier), the server 105 may automatically deduct the amount of the captured coupon from the customer's invoice.

In addition or in the alternative, “rain-checks” also may be captured and stored in the server 105 by activating the button 477 and/or 502. For example, if a particular product has been promoted at a discount price, but that product is no longer in stock, the customer can be encouraged to press the button 477 and/or 502 in order to capture a “rain-check.”

As noted above, captured electronic coupons and/or rain checks are preferably stored in the server 105, so that memory requirements of the display 476 and/or loyalty token 501 may be minimized. However, skilled persons will recognize that such captured promotional data may also be stored in a memory of the display 476 and/or loyalty token 501 depending upon system requirements.

The selected (captured) promotion data (e.g., electronic coupon or “rain-check”) saved in the user profile database 527 preferably also can be recalled at the user's next visit. For example, when the customer pays at the cashier, the consumer's printed receipt can list all captured promotions and optionally the promotion's expiration date. The saved promotions can then be access on the customer's next trip by use of the above-described customer “log in” procedure using the customer's loyalty token 501. In a particularly preferred embodiment, after the customer has been logged in, the shopping cart display 476 can automatically display the list of captured electronic coupons and rain checks so the customer can review all saved promotions. Such a system gives consumers a good reason to return to the same store for their next shopping trip, because they know that they have saved some personally useful promotions (discounts) in the customer profile database 527 that are easily recalled and redeemed on their next visit.

In another embodiment, the promotion optimization application 531 preferably analyzes the historical buying pattern for each consumer to generate a custom promotion or automated shopping list for each consumer. Thus, after the customer has been logged in as described above, such an automated shopping list may be automatically (or upon demand) displayed on the cart handlebar display 476. The consumer can review the promotion or automated shopping list, and preferably scroll up and down the list by using the handlebar buttons 477.

In another embodiment, the handlebar display 476 can suggest items based on the consumer's historical buying pattern. For example, if the customer buys milk on 90% of the customer's visits to the store, but the customer has not yet gone to the milk section, the display 476 may provide a virtual shopping list reminder.

In another embodiment, the loyalty token 501 may be configured to be used in queuing situations. For example, many fresh food sections require the customer to take a number if many customers are waiting to be served. According to the present teachings, the consumer can hold their loyalty token 501 near the queuing place (e.g. deli section) and press the button 477 to register their place in line. In addition or in the alternative, the display 476 may be configured such that the customer can press the button 477 in order to register their place in line. When the customer's turn has arrived (or shortly therebefore), the handlebar 476 can display a message to return to the queuing place. Therefore, the consumer can continue to shop until the handlebar display 476 notifies them that their number is up at the queue.

In another embodiment, the loyalty token can be recognized at the point of sale checkout to eliminate the manual login by phone number or loyalty card barcode scan. For example, the server 105 may determine that the customer has arrived at the cashier based upon the tracking information provided by the display 476 and/or loyalty token 501. Based upon this location information, the server 105 can automatically associate the customer's purchase with the information stored in the customer profile database 527. Thereafter, the customer's current purchases can be stored in the customer profile database 527 and/or the discounts of electronic coupons or rain checks can be deducted from the customer' invoice.

While it is preferable for this association to be made based upon the tracking information, naturally, it is also possible to provide a bar code on a surface of the loyalty token 501. In this case, the customer can scan the bar code upon arriving at the cashier in order to associate the customer's purchases with the information stored in the customer profile database 527.

In another embodiment, the server 105 can sense when a consumer has been in a checkout line longer than a preset threshold and generate an automatic discount for that particular consumer to compensate for the inconvenience.

In another embodiment, the consumer can navigate the store promotions, personal promotions, product index, additional information, automated shopping lists, etc. using a keypad, mouse, touchpad or other input device on the handlebar of the shopping cart.

In another embodiment, the server 105 or alternative servers (not shown) can transmit an email reminder of saved promotions to a consumer's email account to remind them of the saved promotions, expiration dates, automated shopping lists, relevant promotions, etc. In addition or in the alternative, a consumer can modify the information stored in the customer profile database 527, or prepare a personal shopping list online and/or save additional promotions to their personal account in the customer profile database 527. This information can then be subsequently displayed automatically on the cart handlebar 475 during the customer's next visit to the store.

In another embodiment, one of the handlebar buttons 477 can be configured to check off an item from a personal or automated shopping list. In addition or in the alternative, the server 105 can automatically check off a shopping list item or display a simple yes/no question whether an item should be checked off based on analyzing the cart motion (e.g. when cart stops in front of milk for 20 seconds, the display can ask the consumer if he/she would like to check off milk from their personal shopping list).

In another embodiment, the server 105 can compute a minimum length path required to pick up all of the products on a consumer's personal electronic shopping list. Step-by-step instructions (e.g. go toward the front of the store, turn left at the end of the aisle, go to aisle 3, etc.) can be displayed on the cart handlebar display 476.

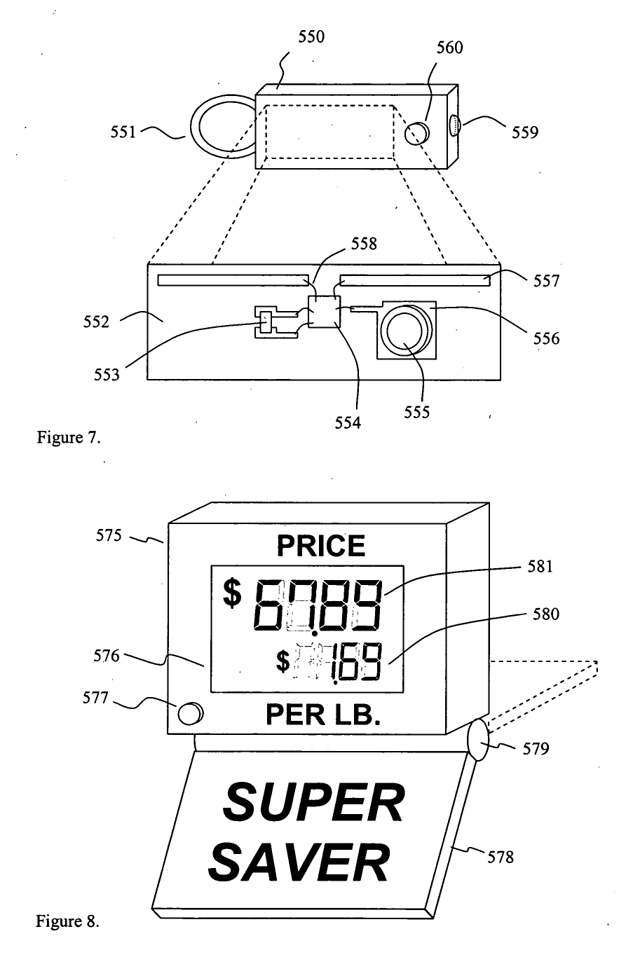

FIG. 7 shows an expanded loyalty token 550 comprising an optional attachment point 551, a printed circuit board 552, one or more passive or external components 553, a wireless controller IC 554, a battery or other power source 555, printed circuit board wiring 556, one or more antennas 557, electrical interconnections (e.g. bond wires) 558, an optional LED or other visual indicator 559 and or more optional buttons 560.

The loyalty token LED 559 can be programmed to emit light upon one or more of the following conditions: a button press, successful user login and/or an “on deck” message for the above-described queuing application. Other software applications can utilize the loyalty token indicator 559 to indicate a message or condition to the customer and are considered within the scope of the present teachings.

FIG. 8 shows an alternative ESL 575 that has been modified to provide a mechanical flag or shelf talker (as known in the art) that can be automatically or semi-automatically deployed by wireless command. ESL 575 is comprised of a display 576, one or more optional buttons 577, a hinged or attachable promotional sign 578, a hinge or other deployment or attach mechanism 579, a unit price 580 segment of the display and a retail price 581 segment of the display.

In one embodiment, the server 105 can send a wireless command to deploy the promotional sign 578. In an additional or alternative embodiment, the server 105 can send a wireless command to retract the promotional sign 578. In addition or in the alternative, the hinge 579 may be spring loaded to deploy or retract the promotional sign 578. In addition or in the alternative, the deployment or retraction of the promotional sign 578 may be performed manually.

In another embodiment, the server 105 can send a wireless command to the ESL 575 to display either on its display 576 or on an optional indicator (e.g. LED, not shown) that a removable promotion sign 578 is required to either be attached or removed by store personnel.

Additional teachings relevant to, and readily combinable with, the present teachings can be found in U.S. provisional patent application Nos. 60/580,678, 60/582,888 and 60/605,568, the contents of which are incorporated herein by reference.

In the foregoing specification, the invention has been described with reference to specific embodiments thereof. It will, however, be evident that various modifications and changes may be made thereto without departing from the broader spirit and scope of the invention. For example, each feature of one embodiment can be mixed and matched with other features shown in other embodiments. Features and processes known to those of ordinary skill may similarly be incorporated as desired. Additionally and obviously, features may be added or subtracted as desired. Accordingly, the invention is not to be restricted except in light of the attached claims and their equivalents.

1. An electronic shelf label comprising:
a display adapted to display text information,
a wireless transceiver,
an input device,
a battery,
a controller in communication with the display, wireless transceiver, input device and battery, wherein the controller is arranged and constructed to generate a signal, such as an out-of-stock message and/or an item re-stocked message, upon detecting manipulation of the input device and the wireless transceiver is arranged and constructed to transmit said message.

2. An electronic shelf label as in claim 1, further comprising a tamper sensor in communication with the controller.

3. An electronic shelf label as in claim 1, further comprising an antenna in communication with the wireless transceiver.

4. An electronic shelf label as in claim 1, wherein the text information includes price information.

5. An electronic shelf label as in claim 1, wherein the text information includes promotional information.

6. A method comprising steps of:
transmitting a first signal from a first wireless tag comprising a wireless transceiver operated by a battery-powered controller, the first signal comprising at least a unique customer identification code,
determining the location of the first wireless tag based upon the transmitted first signal and thereafter tracking movement of the first wireless tag,
transmitting a second signal from a second wireless tag comprising a wireless transceiver and a display operated by a battery-powered controller,
determining the location of the second wireless tag based upon the transmitted second signal and thereafter tracking movement of the second wireless tag, and
associating the first wireless tag with the second wireless tag based upon a correlation between the tracked movements of the first and second wireless tags.

7. A method as in claim 6, wherein the associating step comprises the step of tracking the movement of the first and second wireless tags.

8. A method as in claim 6, further comprising the step of
generating a third signal based at least in part upon the unique customer identification code,
transmitting the third signal to the second wireless tag, and
displaying information encoded in the third signal on the display of the second wireless tag.

9. A method as in claim 8, further comprising the step of
transmitting a fourth signal from a third wireless tag comprising a wireless transceiver operated by a battery-powered controller, the fourth signal comprising at least a product identification code, and
determining the location of the third wireless tag based upon the transmitted fourth signal.

10. A method as in claim 9, wherein the step of generating a third signal includes generating the third signal at least in part upon the unique product identification and location of the first wireless tag relative to the third wireless tag.

11. A method as in claim 10, wherein the third wireless tag is an electronic shelf label.

12. A method as in claim 11, wherein the electronic shelf label includes a display.

13. A method as in claim 12, wherein the step of displaying information encoded in the third signal includes displaying the information encoded in the third signal on the display of the second wireless tag or on the display of the electronic shelf label.

14. A method as in claim 13, wherein the information encoded in the third signal is a shopping list.

15. A method as in claim 13, wherein the information encoded in the third signal is a product promotion.

16. A method as in claim 13, wherein the information encoded in the third signal is a coupon.

17. A method as in claim 6 wherein the step of determining the location of the first wireless tag includes receiving the first signal at a plurality of access points and determining the location of the first wireless tag based in part on when the first signal is received at each of the plurality of access points.

18. A method as in claim 6 wherein the second wireless tag is coupled to a cart.

19. A wireless system comprising
a first wireless tag comprising a wireless transceiver operated by a battery-powered controller, the first wireless tag storing at least a unique customer identification code and being arranged and constructed to transmit signals including the unique customer identification code,
a second wireless tag comprising a wireless transceiver and a display operated by a battery-powered controller,
one or more wireless access points arranged and constructed to transmit signals to and receive signals from the first and second wireless tags,
at least one central processor in communication with the one or more wireless access points, the at least one central processor being arranged and constructed to:
determine the locations of the first and second wireless tags based upon signals transmitted from the first and second wireless tags to the one or more access points, and then track movement of the first and second wireless tags, and
associate the first wireless tag with the second wireless tag based upon a correlation between the tracked movements of the first and second wireless tags.

20. A wireless system as in claim 19, wherein the at least one central processor is further arranged and constructed to:
generate a signal based at least in part upon the unique customer identification code, the signal including information to be displayed on the display of the second wireless tag, and
transmit the signal to the second wireless tag via the one or more wireless access points.

21. A wireless system as in claim 22, further comprising
a third wireless tag comprising a wireless transceiver and a display operated by a battery-powered controller,
wherein the at least one central processor being arranged and constructed to:
determine the locations of the third wireless tag based upon signals transmitted from the third wireless tag to the one or more access points.

22. A wireless system as in claim 21, wherein the at least one central processor is further arranged and constructed to:
generate a signal based at least in part upon the unique customer identification code or location of the third wireless tag.

23. A wireless system as in claim 22, wherein the signal including information to be displayed on the display of the second wireless tag or on a display of the third wireless tag.

24. A portable wireless device comprising:
a wireless transceiver,
a battery,
a controller in communication with the wireless transceiver, input device and battery, wherein the controller is arranged and constructed to generate a signal comprising a message, said message comprising a unique customer identification code.

25. A portable wireless device as in claim 24, further comprising:
an input device in communication with the wireless transceiver, the controller being adapted to generate said signal upon detecting manipulation of the input device.

26. A portable wireless device as in claim 24, further comprising a tamper sensor in communication with the controller.

27. A portable wireless device as in claim 24, further comprising an antenna in communication with the wireless transceiver.

28. A method comprising the steps of:
transmitting a signal encoding a promotional offer from a central processor to a display,
displaying the promotional offer on the display,
wirelessly transmitting a signal from a portable wireless device comprising a wireless transceiver, a battery and a controller in communication with the wireless transceiver, input device and battery, wherein the controller is arranged and constructed to include a unique customer identification code in said signal and to generate said signal upon detection of manipulation of said input device, said manipulation indicating acceptance of the promotional offer,
detecting receipt of said signal at the central processor, said signal indicating acceptance of said promotional offer, and
storing said association in a database of the central processor.

29. A method as in claim 28 wherein the display is part of a wireless device comprising a wireless transceiver, a battery and a controller in communication with the wireless transceiver, battery and display.

30. A method as in claim 29 wherein the wireless device is an electronic shelf label (ESL).

31. A method as in claim 30 further comprising the steps of transmitting a signal from the ESL, and determining the location of the ESL based upon the transmitted signal.

32. A method as in claim 31, further comprising the step of generating the signal encoding a promotional code based in part on the location of the ESL.

33. A method as in claim 32, further comprising the step of transmitting a signal from the portable wireless device, and determining the location of the portable wireless device.

34. A method as in claim 32, wherein the step of generating the signal encoding a promotional code includes generating a promotional code based in part on the location of the portable wireless device.

35. A method as in claim 28 further comprising steps of:
transmitting a first signal from the portable wireless device, the first signal comprising at least a unique customer identification code,
determining the location of the portable wireless device based upon the transmitted first signal and thereafter tracking movement of the portable wireless device,
transmitting a second signal from a second portable wireless device comprising a wireless transceiver and the display,
determining the location of the portable wireless device and the second portable wireless device based upon the transmitted second signal and thereafter tracking movement of the second portable device, and
associating the portable wireless device with the second portable wireless device based upon a correlation between the tracked movements of the portable wireless device and second portable wireless device.

36. A method as in claim 35, further comprising the step of generating the signal encoding the promotional offer based at least in part upon the unique customer identification code.
